(19) United States
(12) Patent Application Publication
(10) Pub. No.: US 2015/0284855 A1
(43) Pub. Date: Oct. 8, 2015

(54) ARTICLE WITH PLATED LAYER AND METHOD FOR MANUFACTURING THE SAME, AND HEAT-SHRINKING RESIN FILM

(71) Applicant: CANON COMPONENTS, INC., Saitama-ken (JP)

(72) Inventor: Taisuke IWASHITA, Saitama-ken (JP)

(21) Appl. No.: 14/674,614

(22) Filed: Mar. 31, 2015

(30) Foreign Application Priority Data
Apr. 4, 2014 (JP) 2014-078221
Dec. 17, 2014 (JP) 2014-255414

(51) Int. Cl. C23C 18/16; C08F 14/06

(52) U.S. Cl. CPC C23C 18/1633; C08F 14/06

(57) ABSTRACT

There is provided with an article with a plated layer. The article has a heat-shrinking resin that has been heat shrunk. The article also has a modified part formed on a surface of the heat-shrinking resin. The modified part is formed so that the plated layer precipitates. The article also has a plated layer formed on the modified part.

### BACKGROUND OF THE INVENTION

1. Field of the Invention

The present invention relates to an article with a plated layer and a method of manufacturing the article with a plated layer, and a heat-shrinking resin film.

2. Description of the Related Art

In recent years, with miniaturization of electrical products, there has been a demand for a method of patterning finer and denser wiring, for example, when manufacturing a circuit board. For example, International Publication No. 99/049504 proposes immersion lithography as a method of ensuring a large focal depth while increasing resolution. Immersion lithography is a method in which a high resolution and a large focal depth are obtained by using liquid having a refractive index higher than that of air as a medium between an objective lens of a projection optical system and a resist, so as to capture a high degree of diffracted light. Further, Japanese Patent Laid-Open No. 2013-246340 discloses a method of refining exposure light transmitted through an opening of a photomask to which a light collecting function is imparted.

### SUMMARY OF THE INVENTION

According to an embodiment of the present invention, an article with a plated layer comprises: a heat-shrinking resin that has been heat shrunk; a modified part formed on a surface of the heat-shrinking resin, wherein the modified part is formed so that the plated layer precipitates; and a plated layer formed on the modified part.

According to another embodiment of the present invention, an article with a plated layer comprises: a base material; a heat-shrinking resin that has been heat shrunk and surrounds the base material; and a plated layer formed on a part of the heat-shrinking resin.

According to still another embodiment of the present invention, a method of manufacturing an article with a plated layer comprises the steps of: selectively modifying a part of a surface of a resin so that an electroless plating layer precipitates thereon; shrinking the modified resin; and plating the shrunk resin by electroless plating.

According to still another embodiment of the present invention, a heat-shrinking resin comprises: a surface partially modified so that electroless plating precipitates a plated layer thereon, wherein the heat-shrinking resin is shrunk by heating.

Further features of the present invention will become apparent from the following description of exemplary embodiments (with reference to the attached drawings).

### BRIEF DESCRIPTION OF THE DRAWINGS

FIG. 1 is a view explaining a method of manufacturing a metal-coated article according to Embodiment 1.

FIG. 2 is a flowchart of the method of manufacturing a metal-coated article according to Embodiment 1.

FIGS. 3A and 3B are views showing a mask used in Example 1 and a metal-coated article obtained therein.

FIGS. 4A and 4B are views showing a mask used in Example 2 and a metal-coated article obtained therein.

FIG. 5 is a view explaining a method of manufacturing a metal-coated article according to Embodiment 2.

FIG. 6 is a flowchart of the method of manufacturing a metal-coated article according to Embodiment 2.

FIGS. 7A to 7C are views showing the metal-coated article to be obtained in Embodiment 2.

FIGS. 8A and 8B are views explaining a method of regulating shrinkage using a shrinkage regulation member.

### DESCRIPTION OF THE EMBODIMENTS

An immersion exposure apparatus according to International Publication No. 99/049504 has a possibility of a reduction in yield due to the occurrence of a unique problem that is different from the case of dry exposure, even if the numerical aperture NA can be increased. For example, since pure water is interposed between the objective lens and the resist, this may lead to problems such as dirt due to residual water droplets or evaporation, and leakage of the resist. Further, there is also another problem of high cost of the immersion exposure apparatus.

Although the method according to Japanese Patent Laid-Open No. 2013-246340 can refine the wiring, it does not lead to a size reduction of the circuit board as a whole, since there is no reduction in distance between wiring lines.

According to an embodiment of the present invention, a fine plating pattern can be easily formed on a resin at low cost.

Hereinafter, embodiments to which the present invention is applicable will be described with reference to the drawings. However, the scope of the present invention is not limited to the following embodiments.

First of all, as a method of providing a metal layer having a desired pattern, the semi-additive method, the full-additive method, and the subtractive method will be described. These methods can be used, for example, for manufacturing a circuit board having a wiring pattern provided on a resin, and the thus manufactured circuit board is widely used in the field of electrical products. In the semi-additive method, a metal base layer is formed on a flexible film, and a resist having a desired pattern is formed further thereon by photolithography, followed by electrolytic plating. In the full-additive method, an electroless plating catalyst is deposited on a flexible film, and a resist having a desired pattern is formed further thereon by photolithography, followed by electroless plating. In the subtractive method, a metal foil is formed on a flexible film, and further the metal foil is etched by photolithography in accordance with a desired pattern.

In this way, these methods use the so-called photolithography as a technique for creating a fine pattern. That is, a pattern composed of an exposed part and an unexposed part is created by exposing, to the pattern, a surface of a substrate to which a photosensitive photoresist is applied. A negative photoresist has properties in which the exposed part is cured. Meanwhile, a positive photoresist has properties in which the exposed part is easily dissolved. By selectively using these photoresists depending on the purpose, a part covered by a photoresist and an exposed part are formed on the surface of the substrate. Thereafter, electroless plating, electrolytic plating, etching, or the like, is performed, so that a desired wiring pattern is formed.

All the semi-additive method, the full-additive method, and the subtractive method require a resist pattern corresponding to the wiring pattern to be formed by photolithography. However, there is a limit corresponding to the wavelength of light on the resolution of photolithography, for example, due to diffraction of the light. On the other hand, in the case where the exposure wavelength is shortened in order to increase the resolution, a focal depth δ is reduced at the same time. In conventional exposure apparatuses, the space between the objective lens and the resist is filled with air having a refractive index of about 1, and therefore the focal depth δ is reduced in the same manner as above, even if the numerical aperture NA is increased. Thus, there has been a problem that a process margin of Depth of Field (DOF) is narrowed by increasing the resolution, resulting in further difficulty in the process control. Further, in order to change the exposure wavelength, there is a need to change materials such as the lens material and the resist material that are susceptible to the influence of the exposure wavelength, in addition to the need to newly introduce apparatuses such as an exposure apparatus. For these reasons, a huge investment is required to change the exposure wavelength. Generally, as the wavelength is shortened, the investment amount becomes huge.

The resolution at the time of exposure will be simply described. As a basic equation, the Rayleigh equation (resolution=k1×λ/NA) is used. Here, k1 is a constant determined by the process conditions and the optical system. Further, A denotes the wavelength of exposure light (hereinafter, referred to as exposure wavelength), and NA denotes the numerical aperture of the lens.

It is effective to shorten the exposure wavelength λ and to increase the numerical aperture, for increasing the resolution of the wiring pattern. In order to shorten the exposure wavelength λ, KrF excimer laser (248 nm), ArF excimer laser (193 nm), or the like, can be used as an exposure light source, instead of g line and i line (365 nm) that are the emission line spectrum of mercury. As an exposure light source used in the existing process of mass production of semiconductor devices, KrF excimer laser (248 nm) is mainstream, but ArF excimer laser (193 nm) is also used. Further, the numerical aperture NA is represented by the formula (NA=n·sin θ). Here, n denotes a refractive index of a medium between the object and the objective lens, and θ denotes an angle of a line connecting the outermost periphery at the front end of the objective lens to the focal point with respect to an optical axis at the center of the objective lens.

For improving the constant k1, the following techniques can be used.

1. Phase shift mask: A phase shifter can be provided in a mask. The phase of light transmitted through the phase shifter is changed so as to interfere with light that has not passed therethrough, thereby allowing an overlapping portion to be offset, so that a higher resolution than usual can be obtained.

2. Optical Proximity Correction (OPC): exposure light that is incident parallel to the optical axis is diffracted by the mask, and the diffracted light beams interfere with each other, thereby forming periodic interference fringes. If the pattern pitch of the mask is reduced, the number of interference fringes appearing in the projection lens is reduced, resulting in the loss of fidelity to the mask pattern. Then, phenomena of pattern deformation such as rounded corners of transferred patterns, retraction of line ends, and dimensional deviations due to pitch differences occur. These phenomena are called optical proximity effects. Therefore, in consideration of the deformation in advance, corrections such as forming a step on a pattern edge, adding another pattern, or changing the pattern width can be made, corresponding to the pattern shape.

3. Modified illumination: If the pattern pitch of the mask is reduced, the number of interference fringes appearing in the projection lens is reduced, resulting in the loss of fidelity to the mask pattern. Therefore, the number of interference fringes appearing in the projection lens can be increased by changing the aperture shape of the illumination system, so that resolution can be improved. For example, annular illumination or quadrupole illumination can be used.

4. Double exposure: The first exposure is performed within the resolution limit, using a pattern having a line width and spacing that allow good formation, and further the second exposure is performed on exposed parts at the first exposure and unexposed parts between the exposed parts, so that patterning can be performed. That is, the same pattern is exposed twice. According to this method, the resolution can be doubled in principle. However, the throughput is reduced to half, and high positioning accuracy is required.

5. Multilayer resist: The process dimension can be refined by reducing the thickness of a photoresist. However, when the thickness of the photoresist is reduced, the resistance to etching is degraded, which may possibly reduce the resolution. To deal with this problem, the resist film can be multi-layered. For example, a resist film can be formed by combining a thin upper layer implementing fine patterning and a thick lower layer imparting the resistance to etching and controlling the shape of the resist pattern. At this time, as a resist of the lower layer, a resist that has a resistance to etching when processing the substrate and allows a pattern to be formed under conditions in which the resist of the upper layer is not damaged is selected.

6. Antireflection film: In the case where the base of the photoresist is a metal that tends to reflect light, there is cases where light is obliquely reflected by the stepped part, resulting in distortion of the wiring pattern. This is called halation. Then, a photoresist to which an antireflection agent is added can be applied (ARC: Anti-Reflection Coating), or an antireflection film can be formed in advance on the surface of the substrate to be processed by CVD, sputtering, or the like.

However, in order to increase the resolution in resist pattern formation by improving the constant k1 in the Rayleigh equation (resolution=k1×λ/NA), complex calculations or processes are needed, which may possibly lead to an increase in cost or a reduction in throughput.

### Embodiment 1

The method of manufacturing a metal-coated article according to this embodiment includes a modification step, a shrinkage step, and a plating step. The plating step includes a catalyst deposition step and an electroless plating step, and these steps may be performed continuously, or the shrinkage step may be performed in the course of the plating step. Hereinafter, these steps will be described in detail with reference to the flowchart in FIG. 2.

Modification Step

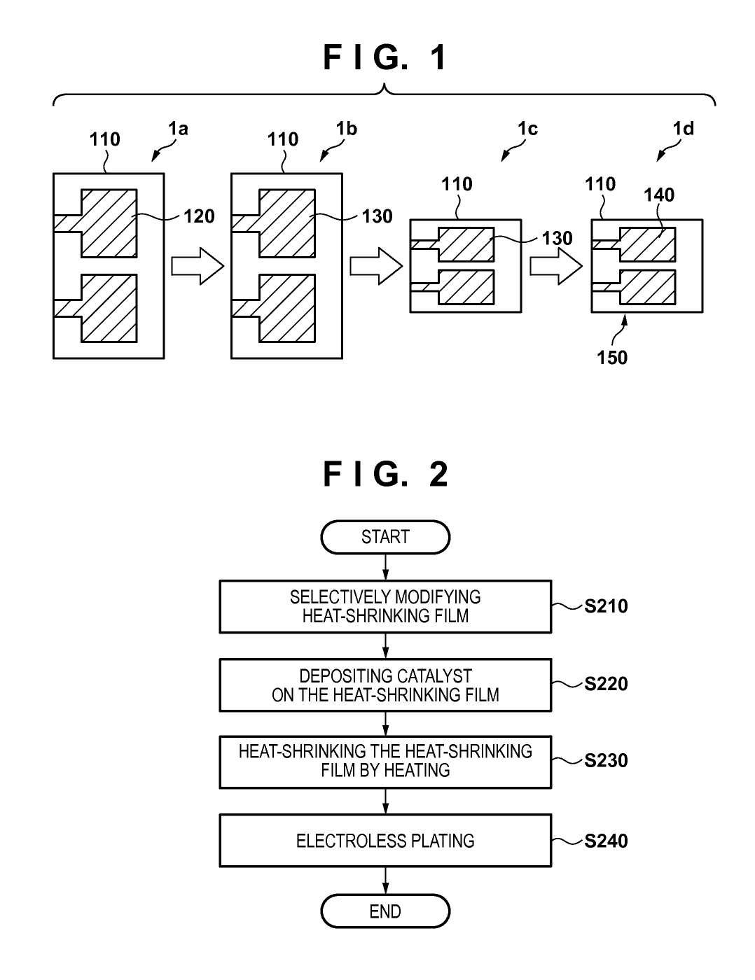

In the modification step (S210), a part of the surface of a heat-shrinking resin is selectively modified so that an electroless plating layer precipitates. As shown in 1a of FIG. 1, a part 120 of the heat-shrinking resin 110 on which the electroless plating layer is to be precipitated is modified, in the modification step. Thus, a modified part is formed on a part of the surface of the heat-shrinking resin 110.

The heat-shrinking resin 110 means a resin that is shrunk when it is heated. The shrinkage ratio by heating is not specifically limited, but the heat-shrinking resin 110 is shrunk in a single axial direction by at least 20% in an embodiment. Use of the heat-shrinking resin 110 having a higher shrinkage ratio, for example, use of a heat-shrinking resin that is shrunk in a single axial direction at a ratio of 40% or more enables a finer plating pattern to be formed.

The type of the heat-shrinking resin 110 is not specifically limited, but examples thereof include polyolefin resins such as polystyrene, polyester resins such as polyethylene terephthalate, and polyvinyl resins such as polyvinyl chloride. The heat-shrinking resin 110 may be a mixture of two or more types of resins.

The heat-shrinking resin 110 is sold to the public and is easily available. The shape of the heat-shrinking resin 110 is not particularly limited, but the heat-shrinking resin 110 in the form of a film having a high shrinkage ratio is used in an embodiment. The thickness of the heat-shrinking resin 110 in the form of a film is not specifically limited, but may be 10 μm or more and 1.0 mm or less, for example.

The heat-shrinking resin 110 in the form of a film can be manufactured, for example, as follows. First, resin beads as a raw material are melted by heating at high temperature so as to be formed, so that a resin film is obtained. Next, the resin film is subjected to electron beam irradiation. The electron beam irradiation causes a crosslinking reaction within the resin film, and thus shape memory properties are imparted to the resin film. Next, while the resin film is heated at low temperature so as to be softened, the resin film is drawn, followed by cooling, thereby fixing the resin film to the drawn state. The thus drawn resin film is strongly distorted, and therefore has properties of shrinking to the original shape when it is heated. When the resin film is drawn in a uniaxial direction, followed by cooling, a resin film that is heat shrinkable in the uniaxial direction can be obtained, and when the resin film is drawn in biaxial directions, followed by cooling, a resin film that is heat shrunk in the biaxial directions can be obtained.

For smooth heat shrinkage, an additive may be added to the heat-shrinking resin 110. Examples of the additive are as follows. When heat, or the like, is applied to the resin, carbon radicals with good reactivity are generated. These radicals react with oxygen in the air so as to be oxidized, thereby causing a deterioration of the resin. For preventing this, a carbon radical scavenger may be added in some cases. Further, silicone-modified polyester may be added for preventing bonding of the resin to itself during heat shrinkage in some cases. Other than these, other additives may be added, as needed.

The heat-shrinking resin 110 can be modified by various existing methods used as a pretreatment of electroless plating of a resin. Examples of the modification method include ultraviolet irradiation, acid treatment using chromium acid or the like, and alkaline treatment using sodium hydroxide or the like, but there is no limitation to these.

In this embodiment, the part 120 of the surface of the heat-shrinking resin 110 on which the electroless plating layer is to be precipitated is selectively modified. For example, in the case of modification by ultraviolet irradiation, the desired part 120 can be selectively irradiated with ultraviolet rays by performing ultraviolet irradiation via a mask having a UV-transmitting part corresponding to the plating pattern to be precipitated. Further, in the case of modification by acid treatment, the desired part 120 can be selectively modified by attaching a mask having an opening corresponding to the plating pattern to be precipitated onto the heat-shrinking resin 110, followed by immersion in acid. In this embodiment, a modification method by ultraviolet irradiation that allows easy selective modification is employed.

Specifically, the surface of the heat-shrinking resin 110 is modified by irradiation with ultraviolet rays in an atmosphere, for example, containing oxygen, ozone, and amine compound gas or amide compound gas. For example, ultraviolet irradiation is performed in an atmosphere containing at least one of oxygen and ozone. In an embodiment, irradiation with ultraviolet rays having a wavelength of 243 nm or less is performed. In an atmosphere containing oxygen or ozone, oxygen molecules in the atmosphere are decomposed by ultraviolet rays having a wavelength of 243 nm or less, so that ozone is generated. The thus generated ozone reacts with a resin such as polyvinyl chloride that is activated by the ultraviolet rays likewise, thereby forming hydrophilic groups such as carboxyl groups on the surface of the heat-shrinking resin 110. Thus, it is considered that the surface of the heat-shrinking resin 110 is modified so as to easily adsorb catalytic ions.

Irradiation with ultraviolet rays as described above can be performed using an ultraviolet lamp that continuously emits ultraviolet rays. Examples of the ultraviolet lamp include a low-pressure mercury lamp and an excimer lamp. The low-pressure mercury lamp can perform irradiation with ultraviolet rays having a wavelength of 185 nm and 254 nm. Further, examples of the excimer lamp that can be used in the ambient atmosphere are shown below for reference. As an excimer lamp, Xe₂ excimer lamp is generally used.
Xe₂ excimer lamp: Wavelength of 172 nm
KrBr excimer lamp: Wavelength of 206 nm
KrCl excimer lamp: Wavelength of 222 nm

When the heat-shrinking resin 110 is irradiated with ultraviolet rays, irradiation with ultraviolet rays is controlled so that the irradiation amount will be a desired value. The irradiation amount can be controlled by changing the irradiation time. Further, the irradiation amount can be controlled also by changing output power of the ultraviolet lamp, the number of the lamps, or irradiation distance.

In an embodiment, for sufficient plating precipitation in a shorter time, the irradiation amount of ultraviolet rays in the irradiation step is 400 mJ/cm² or more and 810 mJ/cm² or less at a wavelength of 185 nm. For example, in an embodiment in which the irradiation intensity of ultraviolet rays is 1.35 mW/cm² at a wavelength of 185 nm, the UV irradiation time is 5 minutes or more and 10 minutes or less. Hereinafter, the irradiation amount and irradiation intensity of ultraviolet rays are values at a wavelength of 185 nm, unless otherwise specified.

However, conditions for plating precipitation may change, for example, depending on the type of plating liquid, the type of heat-shrinking resin, the degree of contamination of the surface of the heat-shrinking resin, the concentration, temperature, pH, and time degradation of plating liquid, and variation in output power of the ultraviolet lamp. Accordingly, the irradiation amount from the ultraviolet lamp may be determined so as to allow selective plating precipitation only on the part irradiated with ultraviolet rays.

Alternatively, ultraviolet laser also can be used as an ultraviolet source. The ultraviolet lamp and ultraviolet laser may be used in combination, as needed. For example, after the part 120 on which the electroless plating layer is to be precipitated is irradiated with ultraviolet laser, the whole of the heat-shrinking resin 110 may be irradiated using the ultraviolet lamp. In this case, the irradiation amounts of the ultraviolet laser and ultraviolet lamp are controlled so that the desired part 120 is modified to the degree that an electroless plating layer precipitates thereon, whereas the other part is modified only to the degree that no electroless plating layer precipitates thereon.

In order to further modify the part 120 irradiated with ultraviolet rays, the heat-shrinking resin 110 after the ultraviolet irradiation may be subjected to alkaline treatment. The further modification facilitates the precipitation of the electroless plating layer on the part 120 irradiated with ultraviolet rays.

In an embodiment, the heat-shrinking resin 110 is treated with an alkali solution in the alkaline treatment. Specifically, the alkaline treatment can be performed by immersing the heat-shrinking resin 110 in the alkali solution. Examples of the alkali solution include a sodium hydroxide aqueous solution, though not specifically limited thereto. The alkaline treatment time, for example, may be 1 minute or more and 10 minutes or less, though not specifically limited thereto. The temperature of the alkali solution in the alkaline treatment, for example, may be 20° C. or more and 100° C. or less, though not specifically limited thereto. There are cases where the heat-shrinking resin 110 contains a material that is modified by the alkaline treatment. In such a case, conditions for the alkaline treatment are selected so that the desired part 120 is modified to the degree that the electroless plating layer precipitates thereon, whereas the other part is modified only to the degree that no electroless plating layer precipitates thereon. For example, the alkaline treatment can be performed using an electroless plating liquid set such as a Cu—Ni plating liquid set “AISL: Adhesion Improvement Seed Layer”, manufactured by JCU CORPORATION.

Catalyst Deposition Step

In the catalyst deposition step (S220), an electroless plating catalyst is deposited on the heat-shrinking resin 110. In the catalyst deposition step, the same method as existing methods used in electroless plating of a resin can be used. For example, the catalyst deposition step can be performed using an electroless plating liquid set such as a Cu—Ni plating liquid set “AISL”, manufactured by JCU CORPORATION.

In an embodiment, the catalyst deposition step can be performed in accordance with the following procedures.

1. The heat-shrinking resin 110 is immersed in a solution containing a binder of the heat-shrinking resin 110 and catalytic ions. Examples of the binder include cationic polymers.

2. The heat-shrinking resin 110 is immersed in a solution containing catalytic ions. Examples of the catalytic ions include palladium complexes such as acidic palladium complex using hydrochloric acid.

3. The heat-shrinking resin 110 is immersed in a solution containing a reductant, thereby reducing the catalytic ions, so that a catalyst precipitates. Examples of the reductant include hydrogen gas, dimethylamine borane, and sodium borohydride.

In the modification step, the part 120 on which the electroless plating layer is to be precipitated is modified so as to have improved hydrophilicity, and thus the catalytic ions selectively adhere to the part 120. Therefore, the catalytic ions adhering thereto are reduced, and then a catalyst that is necessary for electroless plating selectively precipitates on the part 120 on which the electroless plating layer is to be precipitated. 1b of FIG. 1 shows an appearance of the electroless plating catalyst 130 precipitating on the part 120 of the heat-shrinking resin 110 on which the electroless plating layer is to be precipitated.

The catalyst deposition step may include additional procedures, and it is not necessarily essential to perform all the aforementioned procedures. For example, in the case of using a basic amino acid complex of palladium that easily adheres to the part modified to serve as catalytic ions, the step of immersing the heat-shrinking resin 110 in the solution containing the binder can be omitted.

Shrinkage Step

In the shrinkage step (S230), the heat-shrinking resin 110 which is modified in the modification step and on which the catalyst that is necessary for electroless plating is deposited in the catalyst deposition step is shrunk. For example, when the heat-shrinking resin 110 is heated, the heat-shrinking resin 110 is heat shrunk. On the other hand, the resin may be shrunk by another method such as removal of the force drawing the resin from the resin. The shrinkage ratio of the heat-shrinking resin 110 in the shrinkage step differs depending on the type of the heat-shrinking resin 110, and therefore the shrinkage ratio can be controlled by selecting the type of the heat-shrinking resin 110.

The heating temperature can be appropriately selected depending on the type of the heat-shrinking resin 110 so that the heat-shrinking resin 110 is heat shrunk. Generally, the heat-shrinking resin 110 can be heat shrunk by heating within the range of about 80° C. to 200° C. The heating method is not specifically limited, and heating can be performed, for example, using a dryer, an oven, or hot water.

As shown in 1c of FIG. 1, the size of the heat-shrinking resin 110 is reduced due to heat shrinkage. Following this, the size of the part on which the electroless plating catalyst 130 precipitates is also reduced.

In another embodiment, the shrinkage of the heat-shrinking resin 110 is performed while the shrinkage of the heat-shrinking resin 110 is regulated. In such an embodiment, the shrinkage can be controlled so that the heat-shrinking resin 110 after the shrinkage has a desired size.

Hereinafter, an example of a method of regulating the shrinkage of the heat-shrinking resin 110 will be described with reference to FIGS. 8A and 8B. FIG. 8A shows the heat-shrinking resin 110 having a ring shape. For example, the heat-shrinking resin 110 may be in the form of a tube. A shrinkage regulation member 810 is inserted into the ring of the heat-shrinking resin 110. The shrinkage regulation member 810, for example, is a member having a flat plate shape, and a member that is difficult to be shrunk by heat is used therefor in an embodiment. As shown in FIG. 8B, the heat-shrinking resin 110 is shrunk in the state where the shrinkage regulation member 810 is inserted into the ring of the heat-shrinking resin 110. In this case, the shrinkage of the heat-shrinking resin 110 is regulated so that a length h of the heat-shrinking resin 110 after the shrinkage is almost equal to a length h of the shrinkage regulation member 810.

According to such an embodiment, a plurality of sizes of metal-coated articles 150 can be manufactured from a single type of the heat-shrinking resin 110 by using a plurality of shrinkage regulation members 810. That is, while the heat-shrinking resin 110 is modified using the same mask, a plurality of types of metal-coated articles 150 can be manufactured. Further, the wiring pitch also can be controlled by controlling the shrinkage ratio of the heat-shrinking resin 110. In this way, manufacture of multiple types of metal-coated articles 150 is enabled at low cost.

Furthermore, according to the embodiment shown in FIGS. 8A and 8B, the heat-shrinking resin 110 after the shrinkage has a shape along the surface of the shrinkage regulation member 810. Therefore, it is possible to reduce the occurrence of asperities or wrinkles on the heat-shrinking resin 110 during the shrinkage.

It is also possible to cut the heat-shrinking resin 110 after the heat-shrinking resin 110 in the form of a tube is shrunk along the shape of the shrinkage regulation member 810 inserted thereinto.

The method of regulating the shrinkage of the heat-shrinking resin 110 is not limited to the method shown in FIGS. 8A and 8B. For example, the shrinkage can be regulated so that the heat-shrinking resin 110 has a desired shape by shrinking the heat-shrinking resin 110 in the state where two or more points of the heat-shrinking resin 110 before the shrinkage are fixed to another member. As a specific example, the four corners of the heat-shrinking resin 110 in the form of a sheet are fixed to the four corners of a rectangular region of a planar member. At this time, the heat-shrinking resin 110 does not adhere to the planar member so as to allow the shrinkage of the heat-shrinking resin 110. In such a state, the heat-shrinking resin 110 is shrunk, thereby allowing the heat-shrinking resin 110 that has been shrunk to the same size as the rectangular region to be obtained.

Electroless plating step

In the electroless plating step (S240), the heat-shrinking resin 110 after the deposition of the electroless plating catalyst and the heat shrinkage is subjected to electroless plating. By electroless plating, a plated layer or a metal layer can be provided on the heat-shrinking resin 110. In the electroless plating step, the same method as existing methods used in electroless plating of a resin can be used. For example, the electroless plating step can be performed using an electroless plating liquid set such as a Cu—Ni plating liquid set “AISL”, manufactured by JCU CORPORATION.

In the electroless plating step, as shown in 1d of FIG. 1, electroless plating is performed on the heat-shrinking resin 110, thereby allowing an electroless plating layer 140 to precipitate selectively on the part 120 in which the heat-shrinking resin 110 has been modified, that is, the part on which the electroless plating catalyst 130 has precipitated. In other words, the electroless plating layer 140 precipitates on the modified part of the surface of the heat-shrinking resin 110. Due to the aforementioned modification step, nano-level asperities have occurred in the part 120 on which the electroless plating layer is to be precipitated, and therefore high adhesion between the electroless plating layer 140 that has precipitated and the heat-shrinking resin 110 can be obtained.

Specific methods for electroless plating are not specifically limited. Examples of the electroless plating that can be employed include electroless plating using a formalin-based electroless plating bath, and electroless plating using as a reductant hypophosphorous acid that has a low precipitation speed but is easy to handle. Further, in order to form a thicker plating film, the electroless plating layer 140 may be formed using a high-speed electroless plating. Further specific examples of the electroless plating include electroless nickel plating, electroless copper plating, electroless copper nickel plating, and electroless zinc oxide plating.

In order to increase the thickness of the electroless plating layer 140, the heat-shrinking resin 110 may be subjected to further electrolytic plating. Specific methods for electrolytic plating are not specifically limited, and nickel plating, copper plating, or copper nickel plating can be performed, for example. Further, examples of materials for electrolytic plating include zinc, silver, cadmium, iron, cobalt, chromium, nickel-chromium alloy, tin, tin-lead alloy, tin-silver alloy, tin-bismuth alloy, tin-copper alloy, gold, platinum, rhodium, palladium, palladium-nickel alloy, and zinc oxide. Further, there is no problem if displacement plating using silver or the like may be added, as needed.

By performing the aforementioned steps, an article with a plated layer or a metal-coated article 150 can be obtained. The metal-coated article 150 obtained by plating the heat-shrinking resin 110 in accordance with a desired wiring pattern can be used as a circuit board. Use of the circuit board having a fine wiring pattern obtained according to this embodiment makes it easy to manufacture a small device. Further, use of the circuit board having a fine wiring pattern obtained according to this embodiment makes it possible to reduce the wiring space of the device. Therefore, the size of a display area, for example, in a display device can be increased. Further, the metal-coated article 150 obtained by plating the heat-shrinking resin 110 in accordance with a fine stripe pattern can be used as a subwavelength grating that wavelength-selectively transmits light.

Modification

In Embodiment 1, the modification step (S210), the catalyst deposition step (S220), the shrinkage step (S230), and the electroless plating step (S240) are performed in this order. However, the shrinkage step can be performed at an arbitrary timing between the selective modification process of the heat-shrinking resin 110 and the electroless plating process thereof.

For example, after the heat-shrinking resin 110 is modified by irradiation with ultraviolet rays, the heat-shrinking resin 110 may be heat shrunk, followed sequentially by the alkaline treatment, the catalyst deposition, and the electroless plating. Also in this case, a precise plating pattern can be formed with higher resolution than the resolution of selective modification by irradiation with ultraviolet rays.

Further, after the heat-shrinking resin 110 is modified, and catalytic ions are deposited on the modified part, the heat-shrinking resin 110 may be heat shrunk, followed sequentially by reduction of the catalytic ions and electroless plating. In this case, the heat shrinkage may be performed at low temperature, in order to prevent inactivation of the catalytic ions. For example, in the case of employing such procedures, the heat-shrinking resin 110 that is heat shrunk at a temperature of 110° C. or less can be selected.

### Embodiment 2

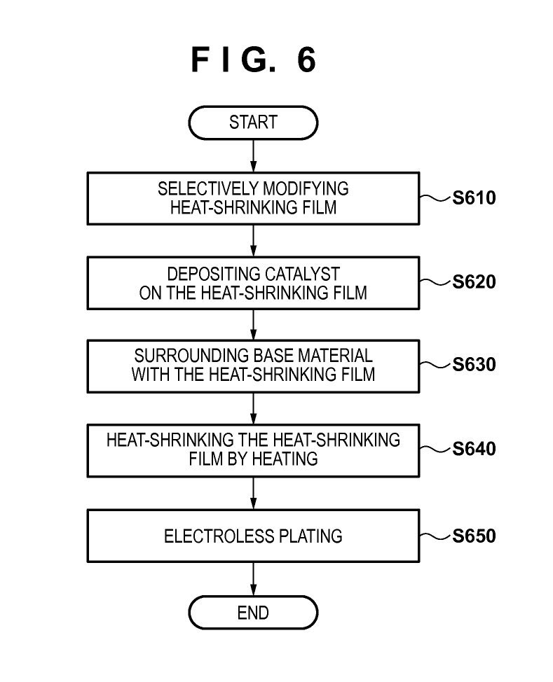

In Embodiment 2, a solid article having a plated layer is manufactured by applying the method of Embodiment 1. A method of manufacturing a metal-coated article according to this embodiment includes a modification step, a step of surrounding a base material with a film, a shrinkage step, and a plating step. Further, the plating step includes a catalyst deposition step and an electroless plating step in the same manner as in Embodiment 1. Hereinafter, the manufacturing method according to this embodiment will be described with reference to the flowchart in FIG. 6.

Modification Step

The modification step (S610) is the same as step S210 in Embodiment 1, and thus the detailed description thereof will be omitted. In this embodiment, a heat-shrinking resin 510 in the form of a film is used. The heat-shrinking resin 510 may be a planar film, or may be in the form of a tube or in the form of an endless belt (hereinafter, simply referred to as the form of a tube). In the case where the heat-shrinking resin 510 is in the form of a tube, several times of modification by ultraviolet irradiation or the like are performed, thereby allowing selective modification to be performed over the entire outer surface of the heat-shrinking resin 510. Use of the heat-shrinking resin 510 in the form of a tube allows a resin film having a plated layer to be provided seamlessly around a base material 550.

As shown in 5a of FIG. 5, a film of the heat-shrinking resin 510 in which a part 520 on which an electroless plating layer is to be precipitated has been modified is obtained by the modification step. The thus obtained heat-shrinking resin film having a surface partially modified so that a metal layer precipitates thereon by electroless plating is useful for providing a metal layer on a base material having a three-dimensional shape, as described below.

Catalyst Deposition Step

The catalyst deposition step (S620) is the same as step S220 in Embodiment 1, and thus the description thereof will be omitted. As shown in 5b of FIG. 5, the heat-shrinking resin 510 in which an electroless plating catalyst 530 has precipitated in the part 520 on which the electroless plating layer is to be precipitated is obtained by the catalyst deposition step.

Step of Surrounding Base Material with Film

In the step of surrounding the base material with a film (S630), the base material 550 is surrounded with the heat-shrinking resin 510 in the form of a film on which an electroless plating catalyst is deposited. The type of the base material 550 is not specifically limited. Examples of materials for the base material 550 include plastic, glass, and wood. The shape of the base material 550 may be an arbitrary shape including a cylindrical shape and a prismatic shape. The base material 550 may be wrapped with the film of the heat-shrinking resin 510 so as to adhere thereto, or voids may be formed between the base material 550 and the film of the heat-shrinking resin 510. 5c of FIG. 5 shows an appearance of the base material 550 surrounded with the film of the heat-shrinking resin 510.

In an embodiment in which the heat-shrinking resin 510 is a planar film, one end and the other end of the film of the heat-shrinking resin 510 are bonded together, thereby forming the heat-shrinking resin 510 into a tube shape. Generally, the base material 550 is surrounded with the heat-shrinking resin 510 so that the heat-shrinking resin 510 is shrunk in the circumferential direction of the heat-shrinking resin 510 in the form of a tube.

As described below, the heat-shrinking resin 510 with which the base material 550 is surrounded is shrunk by heating so as to adhere to the base material 550. Such a technique is widely used in the fields of foods and commodities for packaging containers using heat-shrinking films or for attaching labels to containers. Further, it is also possible to package a curved container with a heat-shrinking film so that characters on the heat-shrinking film are readable. The film of the heat-shrinking resin 510 can be provided on the base material 550 having an arbitrary shape without distortion by employing an appropriate material and an appropriate heating method in accordance with these known techniques.

Shrinkage Step

The shrinkage step (S640) is the same as step S230 in Embodiment 1, and thus the detailed description thereof will be omitted. In the shrinkage step, the film of the heat-shrinking resin 510 with which the base material 550 is surrounded can be selectively heated, for example, using a dryer. Further, the base material 550 and the film of the heat-shrinking resin 510 can be heated at the same time, for example, using an oven. As shown in 5d of FIG. 5, the heat-shrinking resin 510 is heat shrunk so as to adhere to the base material 550.

Electroless Plating Step

The electroless plating step (S650) is the same as step S240 in Embodiment 1, and thus the detailed description thereof will be omitted. In the electroless plating step, the base material 550 provided with the heat-shrinking resin 510 is immersed in an electroless plating liquid, thereby allowing an electroless plating layer to precipitate thereon. 5e of FIG. 5 shows a metal-coated article 560 having a three-dimensional shape obtained by precipitation of an electroless plating layer 540. The obtained metal-coated article 560 has the base material 550, the film of the heat-shrinking resin 510 that surrounds the base material 550 and has been heat shrunk, and the electroless plating layer 540 formed on a part of the film.

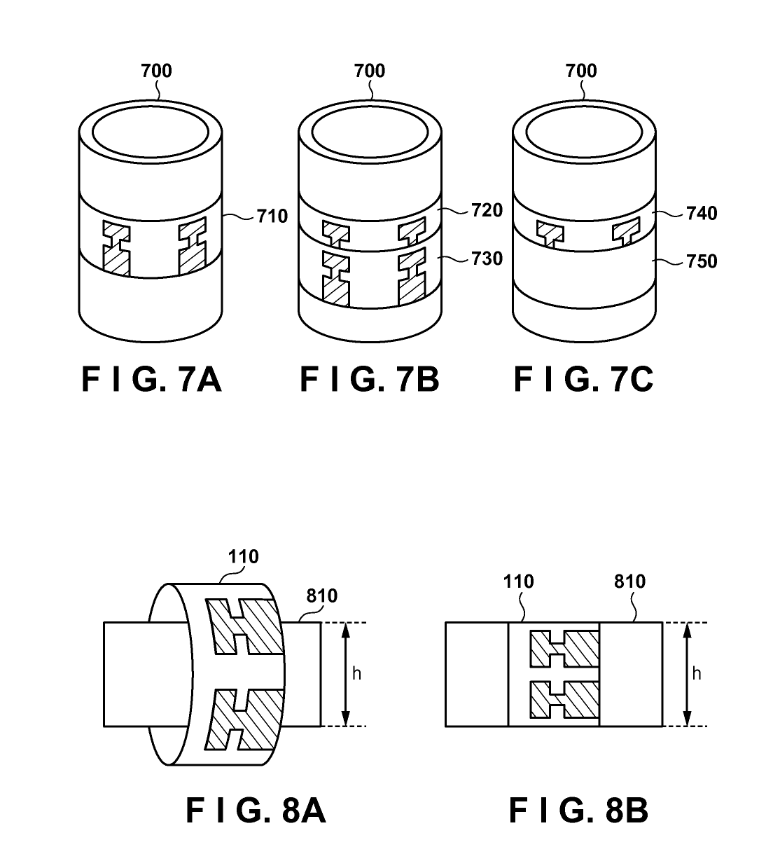

FIGS. 7A to 7C show additional examples of the metal-coated article to be obtained according to this embodiment. FIG. 7A shows an example in which a heat-shrinking resin film 710 having an electroless plating layer is provided on a cylindrical base material 700. Further, multilayer wiring also can be achieved by providing a plurality of heat-shrinking resin films having electroless plating layers. FIG. 7B shows an example in which a heat-shrinking resin film 720 having an electroless plating layer is provided on the base material 700, and a heat-shrinking resin film 730 having an electroless plating layer is provided further thereon. Such a metal-coated article can be manufactured, after the heat-shrinking resin film 720 is provided by performing steps S610 to S650, by repeating steps S610 to S650 further so as to provide the heat-shrinking resin film 730.

Further, it is also possible to protect a heat-shrinking resin film having an electroless plating layer with another heat-shrinking resin film, using the same technique. FIG. 7C shows an example in which a heat-shrinking resin film 740 having an electroless plating layer is provided on the base material 700, and a heat-shrinking resin film 750 is provided further thereon.

In this embodiment, the modification step (S610), the catalyst deposition step (S620), the step of surrounding the base material with a film (S630), the shrinkage step (S640), and the electroless plating step (S650) are performed in this order. However, the shrinkage step may be performed at a different timing, in the same manner as in Embodiment 1. Further, the step of surrounding the base material with a film (S630) also can be performed at an arbitrary timing between the selective modification process of the heat-shrinking resin 510 and the shrinkage process thereof.

According to the method of this embodiment, a metal-coated article having a three-dimensional shape can be manufactured by selectively modifying a heat-shrinking resin in the form of a film. This can be realized by using inexpensive devices such as an ultraviolet lamp and a photomask, where there is no need to use expensive devices such as three-dimensional laser irradiation apparatus for selectively modifying the surface of the base material having a three-dimensional shape. Further, the method of this embodiment enables easy formation of a three-dimensional multilayer wiring pattern, which has been conventionally difficult.

The method of this embodiment can be used regardless of the material and shape of the base material on which a metal layer is intended to be provided. For example, according to the method of this embodiment, a circuit board that can be easily disposed of can be manufactured. For example, a circuit board that can be incinerated can be manufactured by using wood as a base material. Further, a circuit board that can be dissolved in limonene can be manufactured by using polystyrene foam as the base material. Furthermore, the need to use cables for wiring can be eliminated by providing wiring on the surface of a steel pole or a wooden pole used as a construction material.

Further, a small device can be realized by using a cylindrical base material on which wiring is provided in accordance with the method of this embodiment. Such a cylindrical circuit board can be efficiently cooled by allowing refrigerant to pass through the inside thereof, and therefore can be used, for example, as a circuit board for an LED device. Furthermore, since multilayer wiring is easy, antennas such as lightweight omnidirectional collinear antennas or chip antennas can be easily manufactured.

### EXAMPLES

### Example 1

A tube made of vinyl chloride (rod tube A-30, manufactured by SEKISUI CHEMICAL CO., LTD., with a flat width of 55 mm and a thickness of 0.1 mm) was incised, and it was used as a heat-shrinking resin. This heat-shrinking resin was heat shrunk at 100° C.

Modification Step

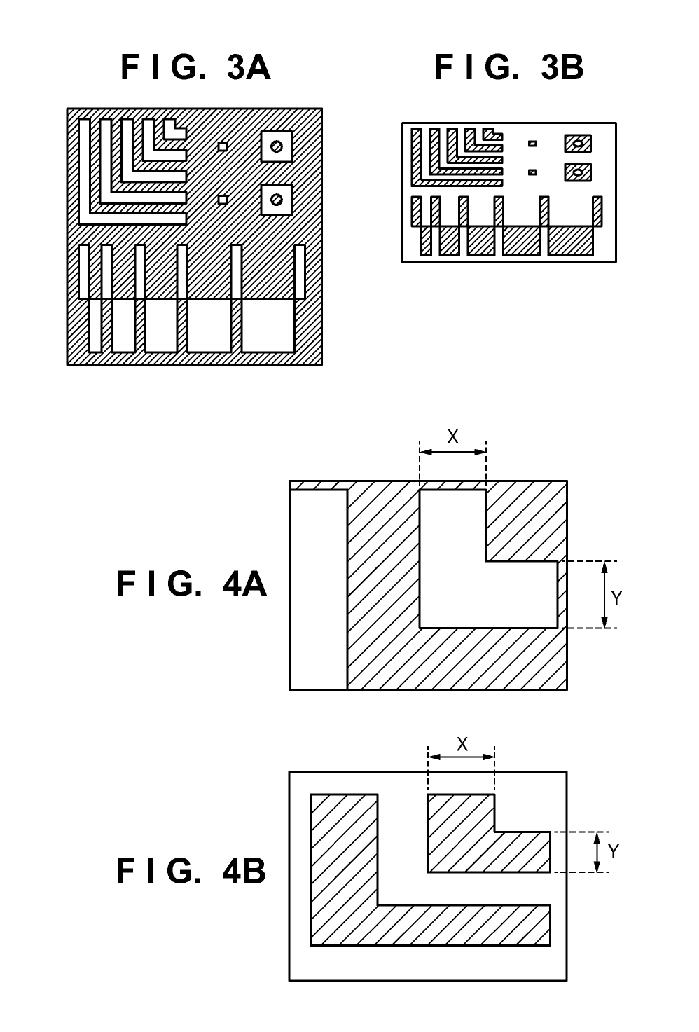

First, a photomask, shown in FIG. 3A, in which patterning with a Cr thin film was formed on a synthetic quartz substrate was set on the heat-shrinking resin. In FIG. 3A, hatched parts indicate parts that do not transmit ultraviolet rays. Next, irradiation with ultraviolet rays via an ultraviolet mask was performed.

The detail of the ultraviolet lamp (low-pressure mercury lamp) used in this example is shown below.

Low-pressure mercury lamp: UV-300, manufactured by SAMCO INC. (dominant wavelength: 185 nm and 254 nm) Illuminance at an irradiation distance of 3.5 cm: 5.40 mW/cm² (254 nm) and 1.35 mW/cm² (185 nm)

Specifically, the heat-shrinking resin was irradiated with ultraviolet rays of 1.35 mW/cm² (185 nm) using the aforementioned ultraviolet lamp at a distance of 3.5 cm from the ultraviolet lamp for 10 minutes. In this case, the integrated exposure was 1.35 mW/cm²×600 seconds=810 mJ/cm².

Next, the heat-shrinking resin irradiated with ultraviolet rays was subjected to alkaline treatment using a Cu—Ni plating liquid set “AISL”, manufactured by JCU CORPORATION. Specifically, an aqueous solution containing sodium hydroxide (3.7 wt %) was prepared and was heated to 50° C., and the heat-shrinking resin after the ultraviolet irradiation was immersed therein for 2 minutes.

Catalyst Deposition Step

Next, the heat-shrinking resin after the alkaline treatment was subjected to the catalyst deposition process, using a Cu—Ni plating liquid set “AISL”, manufactured by JCU CORPORATION. Specifically, the process was performed in accordance with the following procedures.
1. Conditioning treatment (deposition of a binder between catalytic ions and the heat-shrinking resin) (at 50° C., for 2 minutes)
2. Washing with hot water+washing with water+drying (air blowing)
3. Activator treatment (deposition of catalytic ions) (at 50° C., for 2 minutes)
4. Washing with water+drying (air blowing)
5. Accelerator treatment (metalization by reduction of catalytic ions) (at 40° C., for 2 minutes)
6. Washing with water+drying (air blowing)

Shrinkage Step

Next, the heat-shrinking resin was heated by a dryer so as to be heat shrunk. The used dryer can feed hot air at 140° C. near the air-feeding port.

Electroless Plating Step

Next, the heat-shrinking resin after the heat shrinkage was subjected to electroless plating at 60° C. for 5 minutes, using a Cu—Ni plating liquid set “AISL”, manufactured by JCU CORPORATION. Thus, a metal-coated article was manufactured.

A metal layer precipitating on the obtained metal-coated article is shown in FIG. 3B. In FIG. 3B, hatched parts indicate parts where the electroless plating layer precipitated. As shown in FIG. 3B, the electroless plating layer selectively precipitated in parts irradiated with ultraviolet rays.

### Example 2

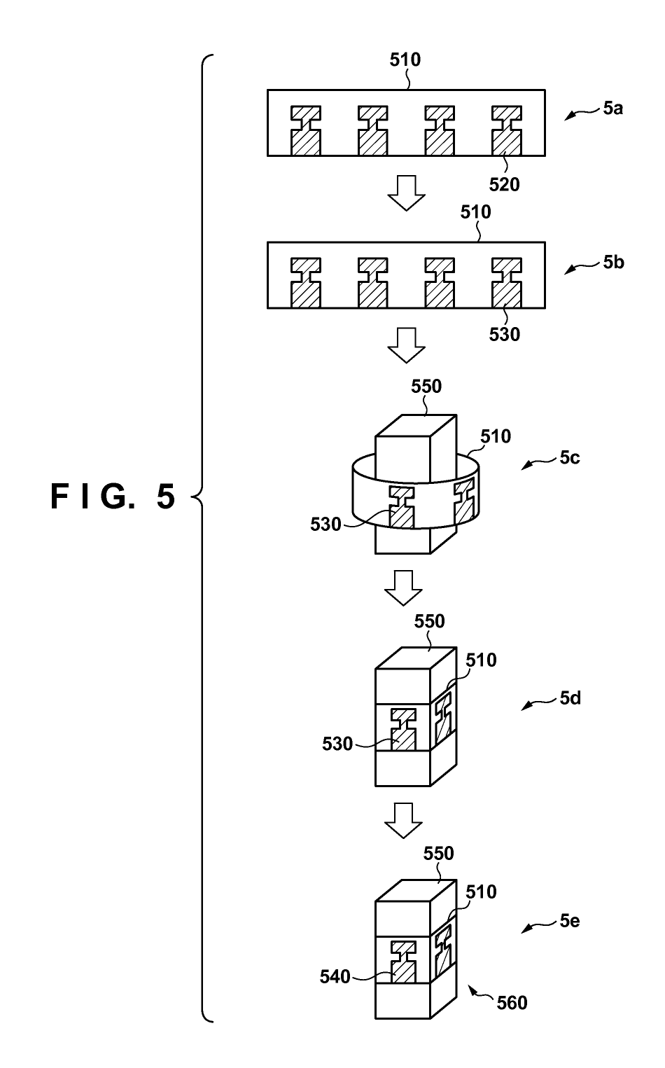

A metal-coated article was manufactured using masks of various sizes in the same manner as in Example 1. An enlarged view of the used masks is shown in FIG. 4A. Further, an enlarged view of the obtained metal-coated article is shown in FIG. 4B.

In the case of using a mask with a dimension X of 352 μm and a dimension Y of 350 μm, the obtained metal-coated article had a dimension X of 325 μm and a dimension Y of 205 μm.

In the case of using a mask with a dimension X of 71 μm and a dimension Y of 70 μm, the obtained metal-coated article had a dimension X of 85 μm and a dimension Y of 56 μm.

In the case of using a mask with a dimension X of 35 μm and a dimension Y of 35 μm, the obtained metal-coated article had a dimension X of 47 μm and a dimension Y of 29 μm.

In the obtained metal-coated article, the parts where the electroless plating layer precipitated tended to be larger than the parts irradiated with ultraviolet rays, although the area of the parts where the electroless plating layer precipitated can be smaller than the area, before shrinking the resin, of the parts irradiated with ultraviolet rays. This tendency is thought to depend on the resolution capability of the ultraviolet irradiation device used in this example. In consideration of such a tendency, it would be possible for those skilled in the art to easily obtain a metal-coated article having a desired plating pattern by controlling the parts to be irradiated with ultraviolet rays.

### Example 3

A tube made of vinyl chloride (rod tube A-30, manufactured by SEKISUI CHEMICAL CO., LTD., with a flat width of 55 mm and a thickness of 0.1 mm) that was the same as in Example 1 was used without incision as a heat-shrinking resin.

The heat-shrinking resin was subjected to the modification step and the catalyst deposition step in the same manner as in Example 1. However, in this embodiment, the heat-shrinking resin was in the form of a tube, and therefore two separate times of ultraviolet irradiation were performed on the outer surface of the heat-shrinking resin folded into a planar shape, i.e., ultraviolet irradiation was performed on one surface of the folded planar heat-shrinking resin, and another ultraviolet irradiation was performed on the opposite surface of the folded planar heat-shrinking resin.

As the base material, a wooden square timber (25 mm square) was used. The base material was passed through the tube of the heat-shrinking resin, thereby allowing the base material to be surrounded with the film of the heat-shrinking resin. Thereafter, the heat-shrinking resin was heated so as to be heat shrunk in the same manner as in Example 1.

Further, the plating step was performed in the same manner as in Example 1, so that a metal-coated article was manufactured. The electroless plating layer selectively precipitated on the parts irradiated with ultraviolet rays. Further, the tube of the heat-shrinking resin adhered to the base material.

### Example 4

A metal-coated article was manufactured in the same manner as in Example 3 except that a shrinkage regulation member that was a plastic plate (45-mm wide) was used as the base material. The obtained metal-coated article had the same width as the plastic plate used as the base material. Further, no asperities or wrinkles were observed in the obtained metal-coated article. The electroless plating layer selectively precipitated on the parts irradiated with ultraviolet rays. Also in the case of using a shrinkage regulation member that was a plastic plate (35-mm wide) as the base material, the same results were obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-078221, filed Apr. 4, 2014, and NO. 2014-255414, filed Dec. 17, 2014, which are hereby incorporated by reference herein in their entirety.

What is claimed is:

1. An article with a plated layer, comprising:
a heat-shrinking resin that has been heat shrunk;
a modified part formed on a surface of the heat-shrinking resin, wherein the modified part is formed so that the plated layer precipitates; and
a plated layer formed on the modified part.

2. An article with a plated layer, comprising:
a base material;
a heat-shrinking resin that has been heat shrunk and surrounds the base material; and
a plated layer formed on a part of the heat-shrinking resin.

3. A method of manufacturing an article with a plated layer, comprising the steps of:
selectively modifying a part of a surface of a resin so that an electroless plating layer precipitates thereon;
shrinking the modified resin; and
plating the shrunk resin by electroless plating.

4. The method of manufacturing an article with a plated layer according to claim 3, wherein
the resin is a heat-shrinking resin, and
the modified heat-shrinking resin is heat shrunk by heating in the shrinkage step.

5. The method of manufacturing an article with a plated layer according to claim 4, wherein
in the shrinking step, the heat-shrinking resin is shrunk by at least 20% in at least one direction.

6. The method of manufacturing an article with a plated layer according to claim 3, wherein
the plating step comprises:
a catalyst deposition step of depositing an electroless plating catalyst on the resin; and
an electroless plating step of electroless plating the resin on which the electroless plating catalyst has been deposited.

7. The method of manufacturing an article with a plated layer according to claim 6, wherein
the modification step, the catalyst deposition step, the shrinking step, and the electroless plating step are performed in this order.

8. The method of manufacturing an article with a plated layer according to claim 3, wherein
in the modification step, a part of the surface of the resin is irradiated with ultraviolet rays.

9. The method of manufacturing an article with a plated layer according to claim 8, wherein
the ultraviolet rays have a wavelength of not more than 243 nm.

10. The method of manufacturing an article with a plated layer according to claim 8, wherein
the irradiation with ultraviolet rays is performed in an atmosphere containing at least one of oxygen and ozone.

11. The method of manufacturing an article with a plated layer according to claim 8, wherein
in the modification step, alkaline treatment is further performed.

12. The method of manufacturing an article with a plated layer according to claim 3, further comprising the step of
surrounding a base material with a film of the resin, the step being performed between the modification step and the shrinkage step.

13. The method of manufacturing an article with a plated layer according to claim 3, wherein
in the shrinking step, the shrinkage of the resin is regulated in shrinking the resin.

14. The method of manufacturing an article with a plated layer according to claim 13, wherein
the resin has a ring shape, and
in the shrinkage step, the resin is shrunk, with a shrinkage regulation member being inserted into the ring.

15. A heat-shrinking resin comprising:
a surface partially modified so that electroless plating precipitates a plated layer thereon, wherein
the heat-shrinking resin is shrunk by heating.
